(19) United States
(12) Patent Application Publication
(10) Pub. No.: US 2026/0118154 A1
(43) Pub. Date: Apr. 30, 2026

(54) SYSTEM AND METHOD TO EVACUATE AND CAPTURE VARIOUS LIQUID AND GAS HYDROCARBON FLUIDS FROM METER PROVERS

(71) Applicant: ZENRG Services, LLC, Houston, TX (US)

(72) Inventors: Sam EDWARDS, Sugar Land, TX (US); Joe CHANDLER, Houston, TX (US); Cameron BRASIER, Spring, TX (US); Ronald WILLIAMS, Kingwood, TX (US)

(21) Appl. No.: 19/003,377

(22) Filed: Dec. 27, 2024

Related U.S. Application Data
(60) Provisional application No. 63/615,831, filed on Dec. 29, 2023.

(51) Int. Cl. G01F 25/10; B08B 9/035

(52) U.S. Cl. CPC G01F 25/11; B08B 9/035

(57) ABSTRACT

Systems and methods are provided for evacuating and recapturing fluids from meter provers. The systems and methods include a pump having an inlet and an outlet, a first conduit arranged to couple the inlet to a discharge section of a prover after completing a calibration of a meter of a flowline, a second conduit arranged to couple the outlet to any one of a downstream section of the flowline, a containment pipeline and a pressure vessel, and a controller communicatively coupled to the pump and arranged to cause the pump to perform operations including: pulling the fluid from an upstream section of the flowline into the prover, pulling the fluid from the discharge section of the meter at a first pressure, cross-compressing the fluid, and pumping the fluid at the second pressure into any one of the downstream section of the flowline, the containment pipeline and the pressure vessel.

### CROSS-REFERENCE TO RELATED APPLICATIONS

This application claims priority under 35 U.S.C. § 119(e) to U.S. Provisional Application No. 63/615,831, filed December 29, 2023, and entitled “METHOD TO EVACUATE AND CAPTURE VARIOUS LIQUID AND GAS HYDROCARBON FLUIDS FROM METER PROVERS,” the contents of which are hereby incorporated by reference in their entirety.

### FIELD

The subject matter herein relates to systems and methods for evacuating and recapturing various liquids and gas hydrocarbon fluids from meter provers.

### BACKGROUND

Meter provers are devices which may be used to calibrate existing inline meters, typically at custody transfer points of pipelines or facilities. The calibration process occurs by flowing a fluid, like a liquid, a gas or a mix, through the inline meters and comparing the records and results of the fluid flow with the results and records of an additional meter, known as a meter prover.

Meter provers may be installed permanently or as part of a mobile unit. For the wished parameters, the results of the inline meter are compared with the results of the meter provers, allowing to potentially adjust or calibrate the inline meter. Meter provers can be drum and piston units able to move at a known calculated volume of fluid. The known calculated volume of fluid and derived flow enables to compare and calibrate potential inline meters with high accuracy. Typical volumes of fluid contained in meter prover units can be between 0.1 and 10 barrels [0.016 to 1.6 m3] of fluid.

### SUMMARY

In one aspect a method for evacuating and recapturing various liquids and gas hydrocarbon fluids from meter provers is provided. The method can include coupling a discharge section of a meter prover to an inlet section of a pump or compressor after completing a calibration of an inline meter of an oil and gas flowline, coupling a discharge section of the pump or compressor to any one of a downstream section of the flowline, a containment pipeline and a pressure vessel, and controlling the pump or compressor to pull a fluid from an upstream section of the flowline, into the meter prover using the pump or compressor. In some aspects, the fluid can include a mixture of any of gases, liquids and solids. In some aspects, the method can also include controlling the pump or compressor to pull the fluid from the discharge section of the meter prover at a first pressure, cross-compressing the fluid, using the pump or compressor, to raise a pressure of the fluid from the first pressure to a second pressure higher than the first pressure, controlling the pump or compressor to pump the fluid at the second pressure into any one of the downstream section of the flowline, the containment pipeline and the pressure vessel, controlling the pump or compressor to stop responsive to determining that the fluid has been evacuated from the meter prover.

In some aspects, the discharge section of the meter prover can be coupled to the inlet section of the pump or compressor via a conduit including a sight glass, the method further including monitoring the fluid that is pulled from the discharge section of the meter prover via the sight glass to validate that the fluid is being adequately transferred.

In some aspects, the method can include filtering the fluid pulled from discharge section, via a filter vessel, prior to the fluid entering the inlet section of the pump or compressor to remove any in situ contaminates from the fluid.

In some aspects, the fluid pulled from the upstream section of the flowline into the meter prover can be pulled at a first flow rate and the fluid pumped into any one of the downstream section of the flowline, the containment pipeline and the pressure vessel can be pumped at a second flow rate. In some aspects, the first flow rate can be less than the second flow rate until a pressure within the meter prover is near or below zero psig to ensure desired evacuation is achieved.

In some aspects, the method can include monitoring the first pressure via a first pressure sensor, monitoring the second pressure via a second pressure sensor, controlling the pump or compressor to stop responsive to determining that the first pressure can be below a first pressure range, and controlling the pump or compressor to stop responsive to determining that the second pressure can be above a second pressure range. In some aspects, the first pressure range can include a minimum pressure of 1 psi. In some aspects, the second pressure range can include a maximum pressure that can be determined based on an operating pressure of the downstream section of the flowline, the containment pipeline or the pressure vessel.

In some aspects, the pump or compressor can be any one of a piston type, screw type, diaphragm type, centrifugal type, gear type, lobe type, metering type, progressive cavity type, plunger type and multi-phase type pump or compressor. In some aspects, the pump or compressor can be arranged to displace the fluid in a range of 0 to 250,000 standard cubic feet per hour or 0 to 100 barrels per hour.

In some aspects, the discharge section of the pump or compressor can be coupled to the downstream section of the flowline, and the method can further include a step of controlling a valve of the flowline to open, causing the upstream section to reestablish fluidic communication with the downstream section.

In another aspect, a system for evacuating and recapturing various liquids and gas hydrocarbon fluids from meter provers is provided. The system can include a pump or compressor including an inlet section and an outlet section, a first conduit arranged to couple the inlet section to a discharge section of a meter prover after completing a calibration of an inline meter prover of an oil and gas flowline, a second discharge conduit arranged to couple the outlet section of the pump or compressor to any one of a downstream section of the flowline, a containment pipeline and a pressure vessel and a controller communicatively coupled to the pump or compressor and arranged to cause the pump or compressor to perform operations. In some aspects, the controller can cause the pump or compressor to perform operations including pulling the fluid from an upstream section of the flowline or vessel, into the meter prover, where the fluid can include a mixture of any of gases, liquids and solids, pulling the fluid from the discharge section of the meter prover at a first pressure, cross-compressing the fluid, to raise a pressure of the fluid from the first pressure to a second pressure higher than the first pressure, pumping the fluid at the second pressure into any one of the downstream section of the flowline, the containment pipeline and the pressure vessel, and stopping the flow of fluid responsive to determining that the fluid has been evacuated from the meter prover.

In some aspects, the system can include a sight glass provided in the first conduit between the discharge section of a meter prover and the inlet section of the pump or compressor. In some aspects, the sight glass can be arranged to allow an operator to view the fluid that is pulled from the discharge section of the meter prover.

In some aspects, the system can include a filter vessel provided along the first conduit between the sight glass and the pump or compressor. In some aspects, the filter vessel can be arranged to filter the fluid pulled from discharge section of the meter prover prior to the fluid entering the inlet section of the pump or compressor.

In some aspects, the fluid pulled from the upstream section of the flowline into the meter prover can be pulled at a first flow rate and the fluid pumped into any one of the downstream section of the flowline, the containment pipeline and the pressure vessel can be pumped at a second flow rate and the second discharge pressure. In some aspects, the first flow rate can be less than the second flow rate until a pressure within the meter prover is near or below zero psig to ensure desired evacuation is achieved.

In some aspects, the system can include a first pressure sensor communicatively coupled to the controller and arranged to monitor the first pressure, and a second pressure sensor communicatively coupled to the controller and arranged to monitor the second pressure. In some aspects, the controller can be arranged to cause the pump or compressor to perform operations further including stopping the flow of fluid responsive to determining that the first pressure is below a first pressure range, and stopping the flow of fluid responsive to determining that the second pressure is above a second pressure range. In some aspects, the first pressure range can include a minimum pressure of 1 psi. In some aspects, the second pressure range can include a maximum pressure that can be determined based on an operating pressure of the downstream section of the flowline, the containment pipeline or the pressure vessel.

In some aspects, the pump or compressor can be any one of a piston type, screw type, diaphragm type, centrifugal type, gear type, lobe type, metering type, progressive cavity type, plunger type and multi-phase type pump or compressor.

In some aspects, the pump or compressor can be arranged to displace the fluid in a range of 0 to 250,000 standard cubic feet per hour or 0 to 100 barrels per hour.

### BRIEF DESCRIPTION OF THE DRAWINGS

These and other features will be more readily understood from the following detailed description taken in conjunction with the accompanying drawings, in which:

FIG. 1A is a diagram illustrating one embodiment an exemplary system for evacuating and recapturing product from meter provers;

FIG. 1B is a diagram illustrating another embodiment an exemplary system for evacuating and recapturing product from meter provers;

FIG. 2 is a flow diagram illustrating an exemplary method 200 for evacuating and recapturing product from meter provers;

FIG. 3 is an exemplary control diagram illustrating how controllers can be arranged to automatically control the pumps or compressors described herein; and

FIG. 4 is another exemplary control diagram illustrating how controllers can be arranged to automatically control the pumps or compressors described herein.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Conventionally, when a meter prover has to be inventoried for repair, maintenance, calibration, change in fluid, or for replacement, the process includes flaring, burning, venting or draining most of the fluids, such as liquid gas or mix, contained within the meter prover. A typical result of this process may include the loss of the fluid, with its associated monetary value, and moreover may result in the emissions of rejected fluid or burnt gas into the environment, creating possible safety and environmental hazards.

The subject matter described herein leverages the use of one or more pumps or compressors to remove fluid contents including any in situ contaminates from a product in the meter prover, cross-compress the product to raise a pressure of the product from a first pressure of the product contained in the meter prover and its associated plumbing components to a second pressure at a discharge section of the one or more pumps or compressors, where the second pressure is higher than the first pressure. The one or more pumps or compressors can also be arranged to pump the product, at the second pressure, into the downstream section of the pipeline or vessel while monitoring one or more parameters of the product passing through the meter prover, stop the flow of product into the downstream section of the pipeline or vessel responsive to determining that the one or more parameters are within one or more predetermined ranges of one or more predetermined criteria.

The systems and methods described herein are advantageously capable of removing product from meter provers and re-injecting filtered product back into a section of pipeline or a storage vessel to prevent the loss of the fluid.

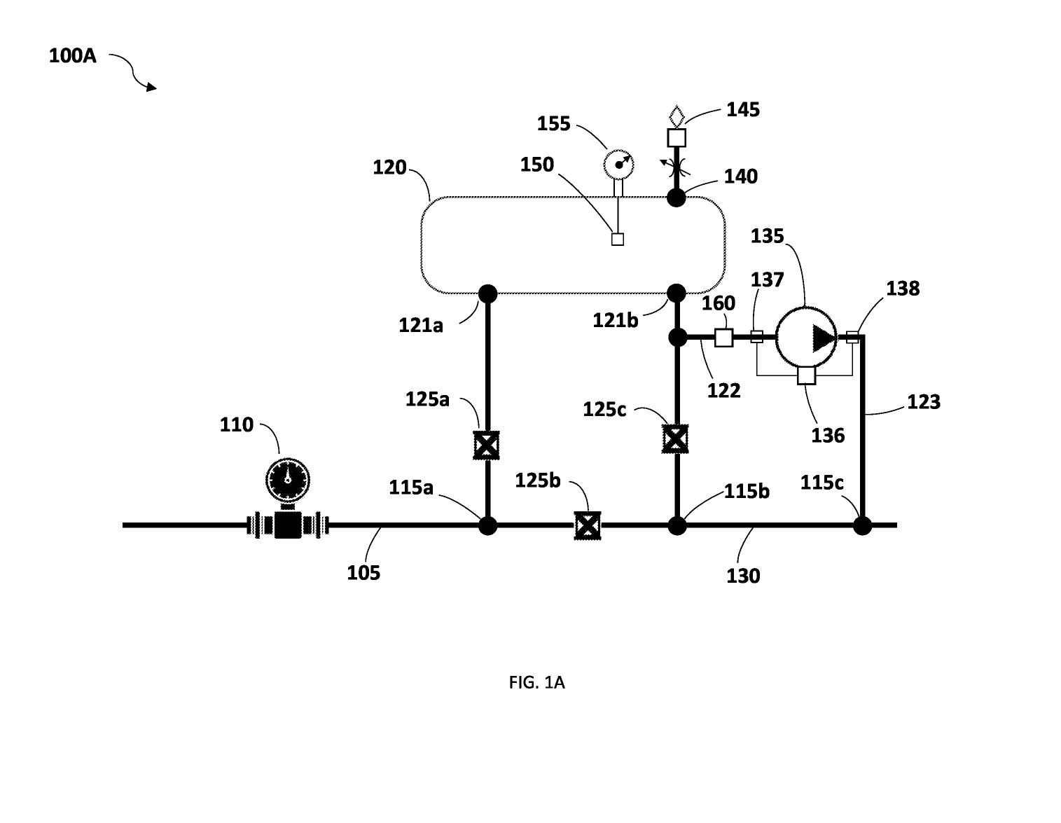

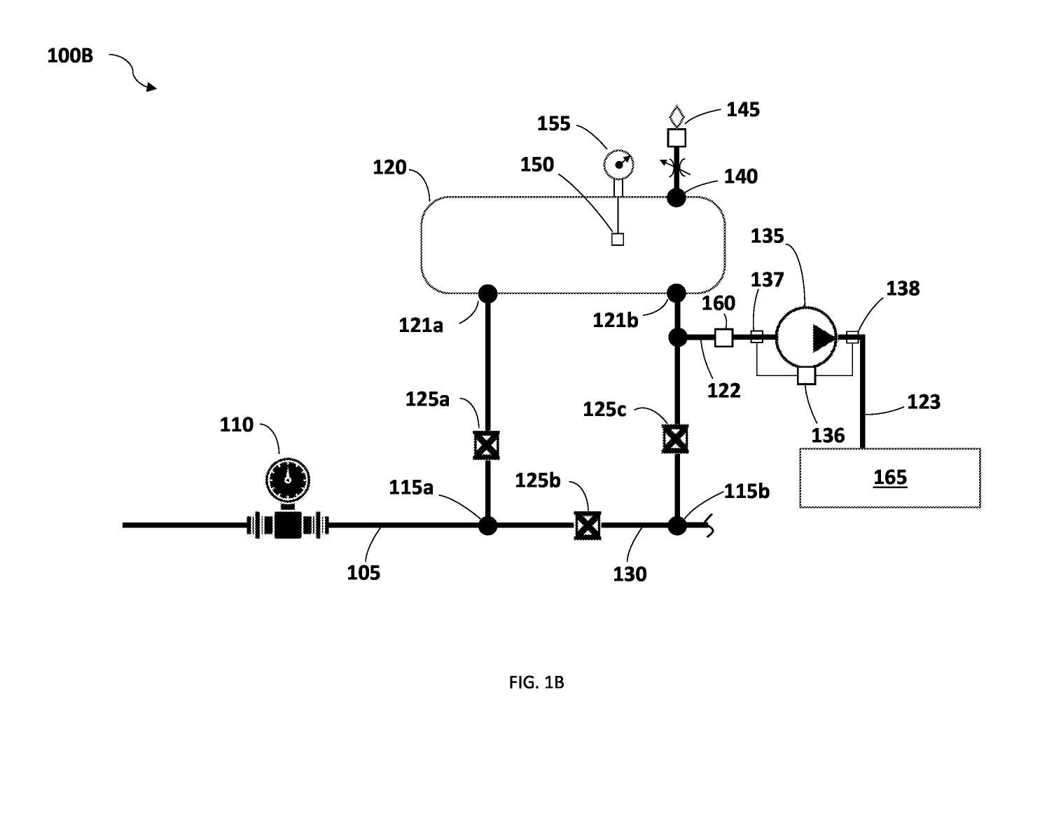

FIG. 1A is a diagram illustrating one embodiment an exemplary system 100A for evacuating and recapturing product from meter provers. As illustrated in FIG. 1A, a main section 105 of an oil and gas flowline may include an inline meter 110. The main section 105 may be a pipe or plurality of pipes as well as hoses which convey a fluid. The fluid may include a mix of liquid or gas, such as hydrocarbons, water, vapor, brine, or combination thereof. In some cases the fluid can also contain solid particulates. The inline meter 110 may typically be installed permanently within the main section 105 to measure various fluid parameters. For example, the inline meter 110 may measure, record, display parameters such as fluid flowrate, fluid volume, fluid density, fluid pressure or other fluid parameters such as temperature, pH, salinity, composition, density, liquid-gas ratio, quality.

In some aspects, the main section 105 can be any location where volumes of gas or liquid hydrocarbon fractionations or chemicals (products) are transferred, including pipeline metering terminals, refineries, tanker/barge loading facilities, petrochemical plants, and power plant fuel metering stations. In some cases, the fluids on the main section can include, for example, Propane, Butylene, Y-Grade, Isobutane, and RGP, however, recovery of other fluids is also realized.

The main section 105 may include a main section tie-in connection 115a allowing to connect a meter prover 120 up hole of the inline meter 110. Meter provers are used in any of the applications described above, to verify the accuracy of flow meters used to measure the substances flowing within the flowlines of the system. The meter prover 120 may include an inlet valve 121a at the entrance or inlet of the meter prover 120, allowing the fluid present inside the main section 105 to flow towards the meter prover 120 after passing through the inline meter 110. The inlet valve 121a as well as an additional block valve 125a may allow to block, open or control the flowrate of the fluid from the main line 105 towards the meter prover 120. In some aspects, the inlet valve 121a or block valve 125a may include various types such as gate valve, globe valve, check valve, ball valve, plug valve, butterfly valve, needle valve, or pressure relief valve. The inlet valve 121a or block valve 125a may be manually remotely or automatically operated or controlled.

An adjoining section 130 may constitute the output line of the meter prover 120. The adjoining section 130 may be in line with the main section 105, as represented in FIG. 1A, or be a different line. Typically, if the adjoining section 130 is in-line with the main section 105, a block valve 125b may isolate both pipe sections, in order to avoid allowing fluid to pass directly between the main section 105 and adjoining section 130, without passing through the meter prover 120.

As the meter prover 120 may be a temporary unit recording fluid parameters of the same fluid passing through the main section 105, the block valve 125b may be part of the permanent installation including the main section 105, or be separate item installed at the time of the meter prover 120 installation.

The meter prover 120 may include an outlet valve 121b allowing to convey the fluid exiting the meter prover back to the adjoining section 130. A block valve 125c may be present to isolate a direct line connection towards the adjoining section 130 at an adjoining section tie-in connection 115b. The type of valves described for the inlet valve 121a and block valve 125a may be similar as the outlet valve 121b, and block valves 125b and 125c.

As depicted in FIG. 1A, a suction side of a pump or compressor 135 may be coupled to the outlet valve 121b via a first conduit 122 and a discharge side of the pump or compressor 135 can be coupled to an adjoining section inlet valve 115c connecting the adjoining section 130 via a second conduit 123. In some aspects, the function of the pump or compressor 135 may be flow the desired fluid present inside the meter prover 120 towards the adjoining section 130. Therefore, any fluid including a mix of gas or liquid may be transferred back to the adjoining section 130 as a discharge, to advantageously recover valuable fluids that are passed into the meter prover 120 during calibration operations. By re-opening the block valve 125b, after the operation of the meter prover 120, the same fluid present inside the main section 105 may be kept for further use after passing through the meter prover 120.

In some aspects, the meter prover 120 may include a purge or vent port 140 towards a purge or flare exit 145, which may typically be used to evacuate contaminants present within the fluid of the main section 105 to avoid to re-introduce those contaminants towards the adjoining section after being discharged from the meter prover 120 and reconnecting the adjoining section 130.

The meter prover 120 may include one or multiple sensors 150 linked to a gauge 155 or a recorder. Typically, the sensors 150 may measure fluid properties of the fluid passing through meter prover 120, similar to the parameters mentioned for the inline meter 110. Additional fluid parameters or more precise measurements may be performed within the meter prover 120 compared to the inline meter 110.

The pump or compressor 135 may include more than one pump or compressor, in series or in parallel. The pump or compressor 135 may be operated manually, remotely, or automated. The pump 135 may function through pneumatic, pressure, electrical mechanical or other hydraulic means. The type of pump or compressor 135 may include piston, screw, diaphragm, centrifugal, gear, lobe, metering, progressive cavity, plunger or multi-phase types. The pump or compressor 135 may displace in the range of 0 to 250,000 scf/hour, as standard cubic feet of gas per hour [0 – 7,000 cubic meters per hour] or 0.1 to 10 Barrels Per Minute of liquid [0.016 to 1.6 cubic meter per minute].

In some aspects, the first conduit can also be provided with a sight glass 160 to allow for an operator to view the fluid that is pulled from the discharge section of the meter prover 120 to ensure that fluid is being adequately pulled from the meter prover 120. In some aspects, the operator can control the pump or compressor 135 to stop the flow of fluid responsive to determining that all of the fluid has been successfully evacuated from the meter prover 120 and recovered into the adjoining section 130.

The pump or compressor 135 can be arranged to pull the fluid from the meter prover 120 at a first pressure and cross-compress the fluid, to raise a pressure of the fluid from the first pressure to a second discharge pressure that is higher than the first pressure. For example, in some aspects, the first pressure can be in a first pressure range of about 1-3 psig, however higher pressures for the first pressure could be realized based on the application. In some aspects, the second pressure can be set to a maximum operating pressure of the fluid in the adjoining section 130. For example, in some aspects the second pressure could be set within a second pressure range of about 285-2,250 psig, however lower and higher pressures for the second pressure could be realized based on the application.

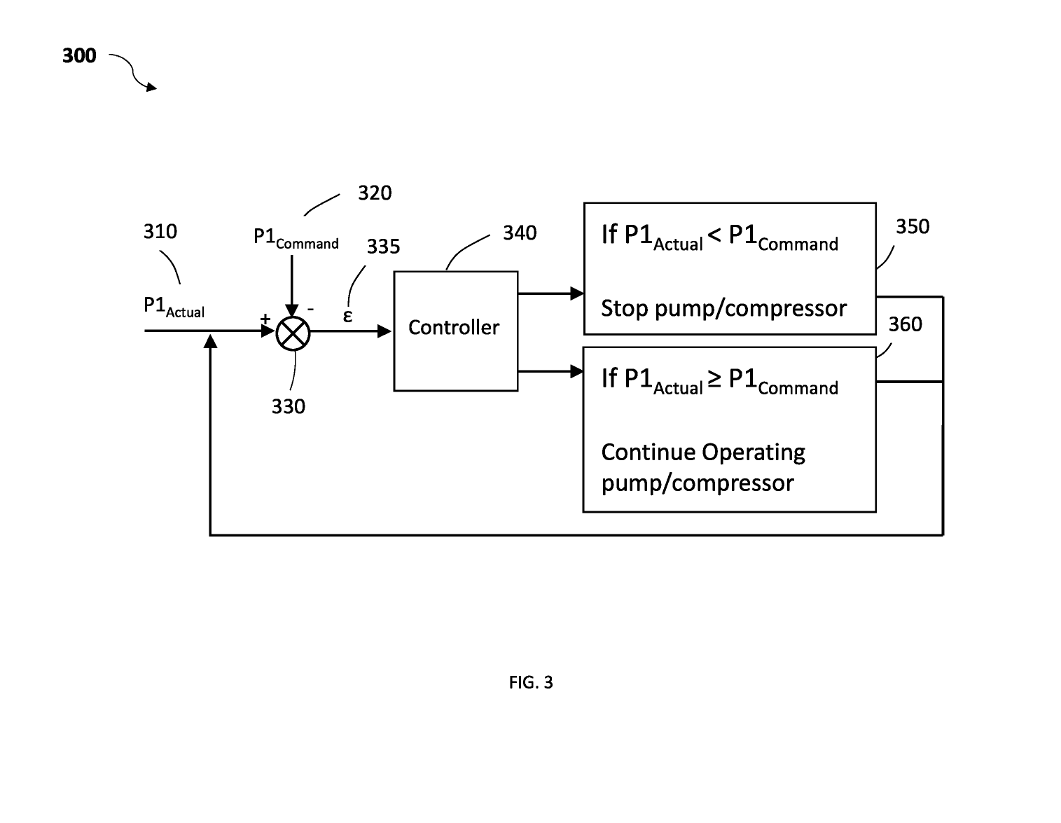

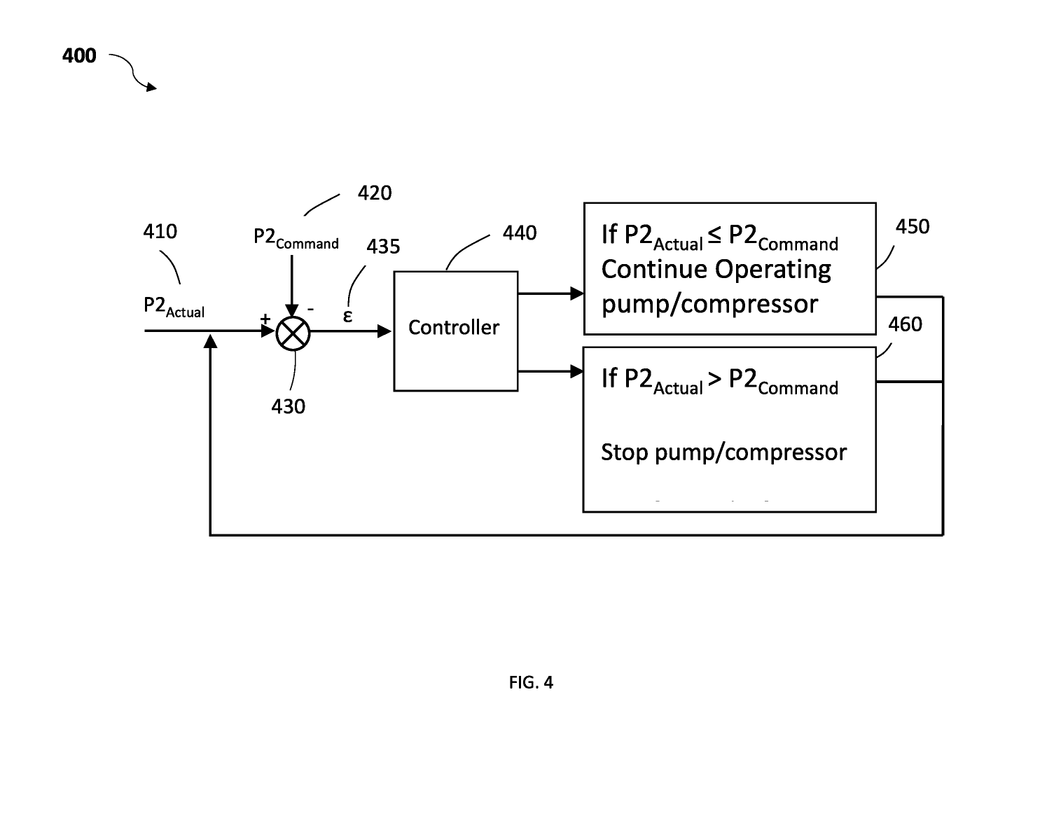

Accordingly, in some aspects, the pump or compressor 135 can be controlled automatically via a controller 136 of the pump or compressor 135. In this case, the system 100A can also include a first pressure sensor 137 communicatively coupled to the pump or compressor 135 via the controller 136 and arranged to monitor the first pressure and a second pressure sensor 138 communicatively coupled to the pump or compressor 135 via the controller 136 and arranged to monitor the second pressure. In this case, the controller 136 can cause the pump or compressor 135 to stop the flow of fluid (e.g., turn off the pump or compressor 135) responsive to determining that the first pressure is below the first pressure range. Similarly, the controller 136 can cause the pump or compressor 135 to stop the flow of fluid (e.g., turn off the pump or compressor 135) responsive to determining that the second pressure is above the second pressure range. In some aspects, the first pressure sensor 137 and the second pressure sensor 138 can be communicatively coupled the controller 136 either wirelessly or via a wired connection. The specifics of the automated pump or compressor control are described in greater detail below in reference to FIGS. 3-4.

In some aspects, the pump or compressor 135 can be designed such that it is capable of displacing the fluid in a range of 0 to 250,000 standard cubic feet per hour or 0 to 100 barrels per hour (e.g., depending on whether the fluid is primarily a gas or a liquid).

FIG. 1B is a diagram illustrating another embodiment an exemplary system 100B for evacuating and recapturing product from meter provers. Many of the components of the system 100B are similar to the system 100A of FIG. 1A, accordingly, like components will not be described. As illustrated in FIG. 1B, in some aspects, rather than coupling the discharge side of the pump or compressor 135 to the adjoining section inlet valve 115c of the adjoining section 130, as shown in FIG. 1A, the system 100B can be arranged to couple the discharge side of the pump or compressor 135 to a containment pipeline or a pressure vessel 165 via the second conduit 123. In some aspects, the function of the pump or compressor 135 may be flow the desired fluid present inside the meter prover 120 towards the containment pipeline/pressure vessel 165. Therefore, any fluid including a mix of gas or liquid may be transferred to the containment pipeline/pressure vessel 165 as a discharge, to advantageously recover all of the valuable fluids that are passed into the meter prover 120 during calibration operations.

In this case, the pump or compressor 135 can be arranged to pull the fluid from the meter prover 120 at the first pressure and cross-compress the fluid, to raise a pressure of the fluid from the first pressure to a second discharge pressure that is higher than the first pressure, similarly to as described above with reference to FIG. 1A. For example, in some aspects, the first pressure can be in a first pressure range of about 1-3 psi, however higher pressures for the first pressure could be realized based on the application. In some aspects, the second pressure can be set to a maximum operating pressure of the fluid in the containment pipeline/pressure vessel 165. For example, in some aspects the second pressure could be set within a second pressure range of about 285-2,250 psig, however lower and higher pressures for the second pressure could be realized based on the application. In some aspects, the pump or compressor 135 can be controlled automatically via a controller 136 and the pressure sensors 137, 138, similarly to as described above.

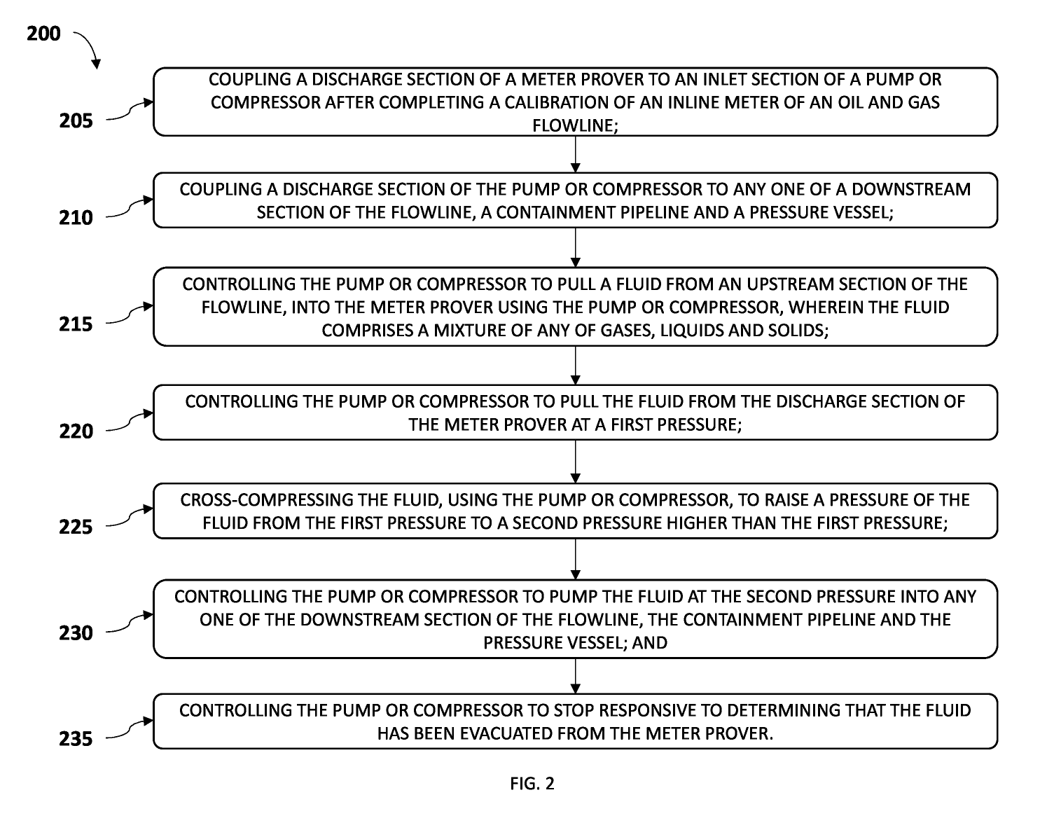

FIG. 2 is a flow diagram illustrating an exemplary method 200 for evacuating and recapturing product from meter provers. The method steps of method 200 are described in greater detail below with reference made to the systems 100A and 100B of FIGS. 1A and 1B. As illustrated in FIG. 2, the method 200 can include a step 205 of coupling a discharge section of a meter prover to an inlet section of a pump or compressor after completing a calibration of an inline meter of an oil and gas flowline. For example, step 205 can include connecting the outlet valve 121b of the meter prover 120 to the suction side of the pump or compressor 135 via the first conduit 122.

In some aspects, the pump or compressor 135 can be any one of a piston type, screw type, diaphragm type, centrifugal type, gear type, lobe type, metering type, progressive cavity type, plunger type and multi-phase type pump or compressor. In some aspects, the pump or compressor can be arranged to displace the fluid in a range of 0 to 250,000 standard cubic feet per hour or 0 to 100 barrels per hour, depending on if the pump or compressor 135 is primarily moving gases or liquids.

In some aspects, the first conduit 122 can include a sight glass (e.g., sight glass 160). In this case, the method can also include a step of monitoring the fluid that is pulled from the discharge section of the meter prover 120 via the sight glass 160 to validate that the fluid is being adequately transferred into the pump or compressor 135. In some aspects, a filter vessel or the like can be provided between the discharge section of the meter prover 120 and the pump or compressor 135 which can be adapted to remove any in situ contaminates from the fluid prior to entering the pump or compressor 135.

The method 200 can also include a step 210 of coupling a discharge section of the pump or compressor to any one of a downstream section of the flowline, a containment pipeline and a pressure vessel. For example, in reference to FIG. 1A, step 210 can include coupling the discharge side of the pump or compressor 135 to the adjoining section inlet valve 115c connecting the adjoining section 130 via the second conduit 123. In another example, in reference to FIG. 1B, step 210 can include coupling the discharge side of the pump or compressor 135 to the containment pipeline or a pressure vessel 165 via the second conduit 123.

The method 200 can also include a step 215 of controlling the pump or compressor to pull a fluid from an upstream section of the flowline, into the meter prover using the pump or compressor. In some aspects, the fluid can include a mixture of any of gases, liquids and solids, examples of which are discussed above.

The method 200 can also include a step 220 of controlling the pump or compressor to pull the fluid from the discharge section of the meter prover at a first pressure. The method 200 can also include a step 225 of cross-compressing the fluid, using the pump or compressor, to raise a pressure of the fluid from the first pressure to a second pressure higher than the first pressure. The method 200 can also include a step 230 of controlling the pump or compressor to pump the fluid at the second pressure into any one of the downstream section of the flowline, the containment pipeline and the pressure vessel.

In some aspects, using either the system 100A or the system 100B, the fluid pulled from the upstream section 105 of the flowline into the meter prover 120 and into the first conduit 122 at step 220 can be pulled at a first flow rate, and at step 230 the fluid can be pumped into any one of the downstream section 130 of the flowline or the containment pipeline/pressure vessel 165 can be pumped at a second flow rate. In some cases, the first flow rate can be less than the second flow rate such that fluid is pulled from the meter prover 120 until a pressure within the meter prover 120 is near or below zero psig to ensure desired evacuation is achieved.

The method 200 can also include a step 235 of controlling the pump or compressor to stop responsive to determining that the fluid has been evacuated from the meter prover.

For example, in some aspects, the systems described herein can include a controller 136, a first pressure sensor 137 and a second pressure sensor 138 communicatively coupled to the pump or compressor 135. In some aspects, the first pressure sensor 137 can be provided between the discharge section of the meter prover 120 and the pump or compressor 135 and arranged to measure the first pressure. Similarly, in some aspects, the second pressure sensor 138 can be provided between the pump or compressor 135 and the downstream section 130 of the flowline or the containment pipeline/pressure vessel 165. In this case, the controller 136 can be arranged to receive first pressure measurements from the first pressure sensor 137 and/or second pressure measurements from the second pressure sensor 138. The controller 136 can compare the first pressure measurements to a predetermined first pressure range and/or compare the second pressure measurements to a predetermined second pressure range. In some aspects, the controller 136 can be arranged to stop the pump or compressor 135 responsive to determining that the first pressure is below a first pressure range and/or stop pump or compressor 135 responsive to determining that the second pressure is above a second pressure range. In some aspects, the first pressure range can include a minimum pressure of 1 psi, however other minimum pressures are also realized. In some aspects, the second pressure range can include a maximum pressure that can be determined based on an operating pressure of the downstream section 130 of the flowline, the containment pipeline or the pressure vessel 165, as described in greater detail below.

In some aspects, when the discharge section of the pump or compressor 135 is coupled to the downstream section 130 of the flowline, the method can further include a step of controlling a valve of the flowline to open, causing the upstream section 105 to reestablish fluidic communication with the downstream section 130.

FIG. 3 is a diagram illustrating a non-limiting example of a control system 300 arranged to control the pumps or compressors described herein (e.g., pump/compressor 135). In some aspects, the control system 300 can include a summing junction 330 and a controller 340, which can be similar to the controller 136 described above. Description of FIG. 3 is provided below with reference made to the systems 100A and 100B of FIGS. 1A and 1B. As shown in FIG. 3, the summing junction 330 can be arranged to receive a first pressure measurement 310 from a first pressure sensor (e.g., first pressure sensor 137) which is arranged to monitor the pressure of the fluid upstream of the pump/compressor 135, as it is pulled from the meter prover 120. The summing junction 330 can also receive a command pressure 320 which can be set based on the pump/compressor specifications or based on the application that the system is being used for. In some aspects, the command pressure 320 be set to a lower limit of the first pressure range. For example, as described above, in a case where the first pressure 310 is between about 1-3 psig, the command pressure 320 can be set to 1 psig. However, higher and lower command pressures are also realized. In this case the summing junction 330 can determine a difference 335 between the first pressure 310 and the command pressure 320 to be provided to the controller 340. If it is determined, based on the difference 335, that the first pressure 310 is less than the command pressure 320, the controller 340 can stop the pump or compressor 135 to stop the flow of fluid, as indicated by control step 350. Alternatively, if it is determined, based on the difference 335, that the first pressure 310 is greater than or equal to the command pressure 320, the controller 340 can continue to operate the pump or compressor 135, as indicated by control step 360. The steps of the control system 300 can be repeated continuously, or in discrete intervals, until it is determined that the first pressure 310 is less than the command pressure 320 and the pump or compressor 135 is turned off.

FIG. 4 is a diagram illustrating another non-limiting example of a control system 400 arranged to control the pumps or compressors described herein (e.g., pump/compressor 135). In some aspects, the control system 400 can include a summing junction 430 and a controller 440, which can be similar to the controller 136 described above. Description of FIG. 4 is provided below with reference made to the systems 100A and 100B of FIGS. 1A and 1B. As shown in FIG. 4, the summing junction 430 can be arranged to receive a second pressure measurement 410 from a second pressure sensor (e.g., second pressure sensor 138) which is arranged to monitor the pressure of the fluid being discharged from the pump/compressor 135, after it is cross-compressed as described above. The summing junction 430 can also receive a command pressure 420 which can be set based on the pump/compressor specifications or based on the application that the system is being used for. In some aspects, the command pressure 420 be set to an upper limit of the second pressure range, which can be determined based on a maximum operating pressure of the fluid in the adjoining section 130 of the oil and gas flowline, or a maximum operating pressure of the fluid in the containment pipeline/pressure vessel 165.

For example, if the system 100A is being used to recover fluid and return it into the adjoining section 130, the maximum operating pressure of the fluid in the adjoining section 130 may be 2,250 psig. Accordingly, the command pressure 420 can be set to 2,250 psig. However, higher and lower command pressures are also realized. In this case the summing junction 430 can determine a difference 435 between the second pressure 410 and the command pressure 420 to be provided to the controller 440. If it is determined, based on the difference 435, that the second pressure 410 is less than or equal to the command pressure 420, the controller 440 can continue to operate the pump or compressor 135, as indicated by control step 450. Alternatively, if it is determined, based on the difference 435, that the second pressure 410 is greater than the command pressure 420, the controller 440 can stop the pump or compressor 135 to stop the flow of fluid, as indicated by control step 460. The steps of the control system 400 can be repeated continuously, or in discrete intervals, until it is determined that the second pressure 410 is greater than the command pressure 420 and the pump or compressor 135 is turned off.

In another example, if the system 100B is being used to recover fluid into a pressure vessel 165, the maximum operating pressure of the pressure vessel 165 may be only about 1,000 psig. Accordingly, the command pressure 420 can be set to 1,000 psig. However, higher and lower command pressures are also realized. In this case the summing junction 430 can determine a difference 435 between the second pressure 410 and the command pressure 420 to be provided to the controller 440 to operate the pump or compressor 135, as described above.

As previously mentioned, the controller 136 can be communicatively coupled to both the first pressure sensor 137 and the second pressure sensor 138. Accordingly, the controller 136 can combine the logic of control systems 300 and 400 of FIGS. 3 and 4 to ensure that the pump/compressor 135 is being controlled based on both upstream and downstream pressure considerations. In this case, the controller 136 can be arranged to perform the steps of both the control system 300 and the control system 400 (either continuously or in discrete intervals) until it is determined that either the first pressure 310 is less than the command pressure 320 or the second pressure 410 is greater than the command pressure 420, and the pump or compressor 135 is turned off.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method comprising:
coupling a discharge section of a meter prover to an inlet section of a pump or compressor after completing a calibration of an inline meter of an oil and gas flowline;
coupling a discharge section of the pump or compressor to any one of a downstream section of the flowline, a containment pipeline and a pressure vessel;
controlling the pump or compressor to pull a fluid from an upstream section of the flowline, into the meter prover using the pump or compressor, wherein the fluid comprises a mixture of any of gases, liquids and solids;
controlling the pump or compressor to pull the fluid from the discharge section of the meter prover at a first pressure;
cross-compressing the fluid, using the pump or compressor, to raise a pressure of the fluid from the first pressure to a second pressure higher than the first pressure;
controlling the pump or compressor to pump the fluid at the second pressure into any one of the downstream section of the flowline, the containment pipeline and the pressure vessel; and
controlling the pump or compressor to stop responsive to determining that the fluid has been evacuated from the meter prover.

2. The method of claim 1, wherein the discharge section of the meter prover is coupled to the inlet section of the pump or compressor via a conduit comprising a sight glass, the method further comprising:
monitoring the fluid that is pulled from the discharge section of the meter prover via the sight glass to validate that the fluid is being adequately transferred.

3. The method of claim 1, further comprising:
filtering the fluid pulled from discharge section, via a filter vessel, prior to the fluid entering the inlet section of the pump or compressor to remove any in situ contaminates from the fluid.

4. The method of claim 1, wherein the fluid pulled from the upstream section of the flowline into the meter prover is pulled at a first flow rate and the fluid pumped into any one of the downstream section of the flowline, the containment pipeline and the pressure vessel is pumped at a second flow rate, wherein the first flow rate is less than the second flow rate until a pressure within the meter prover is near or below zero psig to ensure desired evacuation is achieved.

5. The method of claim 1, further comprising:
monitoring the first pressure via a first pressure sensor;
monitoring the second pressure via a second pressure sensor;
controlling the pump or compressor to stop responsive to determining that the first pressure is below a first pressure range; and
controlling the pump or compressor to stop responsive to determining that the second pressure is above a second pressure range.

6. The method of claim 5, wherein the first pressure range comprises a minimum pressure of 1 psi.

7. The method of claim 5, wherein the second pressure range comprises a maximum pressure that is determined based on an operating pressure of the downstream section of the flowline, the containment pipeline or the pressure vessel.

8. The method of claim 1, wherein the pump or compressor is any one of a piston type, screw type, diaphragm type, centrifugal type, gear type, lobe type, metering type, progressive cavity type, plunger type and multi-phase type pump or compressor.

9. The method of claim 1, wherein the pump or compressor is configured to displace the fluid in a range of 0 to 250,000 standard cubic feet per hour or 0 to 100 barrels per hour.

10. The method of claim 1, wherein the discharge section of the pump or compressor is coupled to the downstream section of the flowline, the method further comprising:
controlling a valve of the flowline to open, causing the upstream section to reestablish fluidic communication with the downstream section.

11. A system comprising:
a pump or compressor comprising an inlet section and an outlet section;
a first conduit configured to couple the inlet section to a discharge section of a meter prover after completing a calibration of an inline meter prover of an oil and gas flowline;
a second discharge conduit configured to couple the outlet section of the pump or compressor to any one of a downstream section of the flowline, a containment pipeline and a pressure vessel; and
a controller communicatively coupled to the pump or compressor and configured to cause the pump or compressor to perform operations comprising:
pulling the fluid from an upstream section of the flowline or vessel, into the meter prover, wherein the fluid comprises a mixture of any of gases, liquids and solids,
pulling the fluid from the discharge section of the meter prover at a first pressure,
cross-compressing the fluid, to raise a pressure of the fluid from the first pressure to a second pressure higher than the first pressure,
pumping the fluid at the second pressure into any one of the downstream section of the flowline, the containment pipeline and the pressure vessel, and
stopping the flow of fluid responsive to determining that the fluid has been evacuated from the meter prover.

12. The system of claim 11, further comprising:
a sight glass provided in the first conduit between the discharge section of a meter prover and the inlet section of the pump or compressor, wherein the sight glass is configured to allow an operator to view the fluid that is pulled from the discharge section of the meter prover.

13. The system of claim 12, further comprising:
a filter vessel provided along the first conduit between the sight glass and the pump or compressor, wherein the filter vessel is configured to filter the fluid pulled from discharge section of the meter prover prior to the fluid entering the inlet section of the pump or compressor.

14. The system of claim 11, wherein the fluid pulled from the upstream section of the flowline into the meter prover is pulled at a first flow rate and the fluid pumped into any one of the downstream section of the flowline, the containment pipeline and the pressure vessel is pumped at a second flow rate and the second discharge pressure, wherein the first flow rate is less than the second flow rate until a pressure within the meter prover is near or below zero psig to ensure desired evacuation is achieved.

15. The system of claim 11, further comprising:
a first pressure sensor communicatively coupled to the controller and configured to monitor the first pressure; and
a second pressure sensor communicatively coupled to the controller and configured to monitor the second pressure,
wherein the controller is configured to cause the pump or compressor to perform operations further comprising
stopping the flow of fluid responsive to determining that the first pressure is below a first pressure range; and
stopping the flow of fluid responsive to determining that the second pressure is above a second pressure range.

16. The method of claim 15, wherein the first pressure range comprises a minimum pressure of 1 psi.

17. The method of claim 15, wherein the second pressure range comprises a maximum pressure that is determined based on an operating pressure of the downstream section of the flowline, the containment pipeline or the pressure vessel.

18. The system of claim 11, wherein the pump or compressor is any one of a piston type, screw type, diaphragm type, centrifugal type, gear type, lobe type, metering type, progressive cavity type, plunger type and multi-phase type pump or compressor.

19. The system of claim 11, wherein the pump or compressor is configured to displace the fluid in a range of 0 to 250,000 standard cubic feet per hour or 0 to 100 barrels per hour.
